(19) United States
(12) Patent Application Publication
(10) Pub. No.: US 2026/0338271 A1
(43) Pub. Date: Oct. 29, 2026

(54) REDUCTION GEAR FOR A POWERTRAIN

(71) Applicant: VALEO EMBRAYAGES, Amiens (FR)

(72) Inventors: Antonin CHERON, Cergy Pontoise (FR); Christophe DHALLEINE, Cergy Pontoise (FR)

(73) Assignee: VALEO EMBRAYAGES, Amiens (FR)

(21) Appl. No.: 19/139,934

(22) PCT Filed: Dec. 20, 2023
(86) PCT No.: PCT/EP2023/086803

§ 371 Date: Jun. 17, 2025

(30) Foreign Application Priority Data
Dec. 23, 2022 (FR) FR2214474

(51) Int. Cl. F16H 57/04; F16H 57/02; F16H 57/021

(52) U.S. Cl. CPC F16H 57/0494; F16H 57/021; F16H 57/0423; F16H 57/043; F16H 57/0457; F16H 2057/02043

(57) ABSTRACT

A speed reducer for a powertrain includes a reduction device comprising a first shaft extending along a first axis of rotation, and a deflector comprising a ramp capable of guiding a lubricant, the deflector being arranged in the housing. The deflector is manufactured as a component distinct from the housing, and wherein the ramp comprises a flow sector, a part of which is situated in the vicinity of the first axis of rotation X.

### TECHNICAL FIELD OF THE INVENTION

The invention relates generally to the technical field of speed reducers, in particular to their lubrication means.

### PRIOR ART

To lubricate a speed reduction device, in particular the bearings, gears, etc., the reducers may be equipped with a pump which circulates a lubricant such as oil in a lubrication circuit configured to reach various specific regions to be lubricated. These devices for lubricating the reducers are referred to as “active” lubrication devices.

There are also so-called “passive” lubrication devices, that is to say ones without a pump, in which ramps are formed within the housing to promote the rise of lubricant from the bottom of the reducer to the top and thus disperse the lubricant in various regions of the reducer.

However, these passive lubrication solutions are not entirely satisfactory and the rise of lubricant from the bottom to the top of the reducer is sometimes not sufficient, in particular when elements of the reduction device, for example a transmission shaft carrying toothed wheels, impede the rise of the lubricant to the top of the reducer.

### SUMMARY OF THE INVENTION

The invention aims to remedy this problem by proposing a speed reducer for a powertrain, comprising:
a reduction device comprising a first shaft extending along a first axis of rotation,
a housing enclosing the reduction device and comprising a first part and a second part, these being axially assembled with one another,
a first bearing arranged to guide the rotation, about the first axis of rotation, of the first shaft, and the first bearing being mounted in a first receptacle of one of the first part of the housing and the second part of the housing, the first bearing having a radially external peripheral contour,
a deflector comprising a ramp able to guide a lubricant, the deflector being arranged in the housing,
wherein the deflector is manufactured as a component distinct from the housing (60), and wherein the ramp comprises a flow sector which is situated closer to the first axis of rotation than the radially external peripheral contour of the first bearing.

It will be understood here that the above-mentioned flow sector denotes a part of the ramp situated relatively close to the first axis of rotation with respect to the rest of the ramp which is less close to the first axis of rotation, in particular less close to the first axis of rotation than the radially external peripheral contour of the first bearing.

Thus, by approaching the first axis of rotation, it is possible to cause the ramp to rise higher in the reducer despite the presence of a transmission shaft. This promotes the flow of the lubricant toward the top of the reducer. With the deflectors known from the prior art in which the deflectors are formed in the mass of the housings, the installation of the deflectors is limited and the flow of the oil toward the top of the reducer is sometimes insufficient.

The term bearing refers here to plain bearings and equally to rolling bearings.

The reducer may also comprise at least one of the following features:
The flow sector is arranged at least partially in a space in the form of a right circular cylinder centered on the first axis of rotation and having a diameter equal to the outside diameter of the first bearing.
The first shaft coaxially carries a plurality of toothed wheels, and the flow sector is also arranged closer to the first axis of rotation than the radially external periphery of the toothed wheel of largest diameter carried by the first shaft.
The flow sector is an end region of the ramp of the deflector.
The reduction device comprises a first toothed wheel carried coaxially, with respect to the first axis of rotation, by the first shaft.
The first toothed wheel comprises a hub, two flanks and a toothed peripheral band, the flow sector being arranged so as to splash the lubricant against a flank of the first toothed wheel. Such an arrangement makes it possible to improve the lubrication of the reducer. Specifically, the splashing of the lubricant against the flank of the first toothed wheel makes it possible to promote the flow of the lubricant toward the top of the reducer, the lubricant being driven by the first toothed wheel.
The flow sector is arranged, axially along the first axis of rotation, between the first toothed wheel and the first bearing.
The flank of the first toothed wheel against which the lubricant guided by the ramp is splashed comprises an annular groove inside which a part of the flow sector is arranged.
The flow sector is arranged, radially with respect to the first axis of rotation, closer to the first axis of rotation than the radially external periphery of the first toothed wheel.
The first bearing supports a first end of the first shaft.
The deflector is fixed with respect to the housing.
The deflector is made of plastic, for example using an injection molding method.
The deflector comprises a mounting portion comprising a plurality of fixing elements collaborating with complementary fixing elements arranged in the housing of the reducer.
The housing of the reducer comprises a first part and a second part, these being assembled with one another, enclosing the reduction device.
The first bearing is mounted in a first receptacle of the first part of the housing and a second bearing makes it possible to guide the rotation, about the first axis of rotation, of the first shaft; the second bearing being mounted in a second receptacle of the second part of the housing, and the flow sector is situated closer to the first axis of rotation X than the radially external peripheral contour of the second bearing.
The fixing elements are arranged in such a way that at least one fixing element is fixed to the first part of the housing and at least one fixing element is fixed to the second part of the housing.
The annular groove is open axially to one side of the first toothed wheel.
The first toothed wheel comprises a wheel disk connecting the hub and the toothed peripheral band.
The annular groove of the first toothed wheel is delimited on a flank of the first toothed wheel by the hub, the wheel disk and the toothed peripheral band.
The ramp comprises a main guideway and an axial protrusion extending the main guideway and projecting axially from the main guideway, the axial protrusion being arranged partly or entirely inside the annular groove of the first toothed wheel.
The main guideway is arranged entirely outside the annular groove of the first toothed wheel.
The reduction device comprises a second toothed wheel able to be rotated about a second axis of rotation parallel to the first axis of rotation, the second toothed wheel comprising a toothed peripheral band arranged radially, with respect to this second axis, facing the main guideway of the ramp.
The diameter of the second toothed wheel is greater than the diameter of the first toothed wheel, for example between 1.5 and 4 times greater.
According to one embodiment, the first axis of rotation is arranged, when the reducer is in a position corresponding to that adopted when mounted on a vehicle parked horizontally, above the second axis.
A horizontal plane tangential to the first wheel and situated below the first axis is arranged higher up than a horizontal plane tangential to the second wheel and situated below the second axis.
The first wheel is arranged above the level of the oil, in particular below the nominal level NN.
The first toothed wheel and the second toothed wheel are offset axially relative to one another.
In particular, if considering, on the one hand, a first plane passing through the first axis of rotation and the second axis of rotation and, on the other hand, a second plane corresponding to the horizontal plane passing through the second axis of rotation, an angle of between 10 and 45 degrees separates the first plane and the second plane.
The ramp, notably the main guideway of the ramp, is:
   arranged so as to cover a portion of the second toothed wheel, along a limited angular sector with respect to the second axis of rotation, and
   spaced away from the toothset of the second toothed wheel so as to allow the lubricant to flow between the ramp and the second toothed wheel.
The angular sector may be comprised between 20 and 90 degrees, for example between 30 and 50 degrees.
The main guideway is spaced away from the second toothed wheel by a first clearance.
The second toothed wheel is a drive wheel of a differential-drive device.
The main guideway has a shape that hugs the toothed peripheral band of the second toothed wheel covered by the ramp.
The first clearance is between 2 and 5 mm.
The toothset of the second toothed wheel is inclined, for example helically, the inclination of the toothset being such that the lubricant is directed axially to the side of the first toothed wheel.
The deflector comprises a shield arranged to at least one side of the ramp so as to prevent the lubricant from dropping off that side of the ramp.
According to one variant, the shield is formed on the housing.
The shield extends in a plane substantially perpendicular to the second axis of rotation.
The shield is situated on the same side of the ramp as the first toothed wheel.
The shield and the axial protrusion are situated on the same side of the main guideway of the ramp.
The mounting portion is equipped with a plate extending substantially in a plane perpendicular to the first axis of rotation, and the fixing elements are arranged on each side of the plate.
The fixing elements are mounting studs and the complementary fixing elements belonging to the housing are mounting receptacles.
The fixing studs project from the plate.
The reduction device comprises a third toothed wheel made to rotate about the first axis of rotation and meshing with the second toothed wheel, the second toothed wheel and the third toothed wheel being arranged in the same plane, the third toothed wheel being arranged beyond an upper end of the ramp of the deflector.
The outside diameter of the third toothed wheel is smaller than the outside diameter of the annular groove.
The third toothed wheel is spaced away from the ramp by a distance less than 3 cm, preferably less than 2 cm.
The third toothed wheel is an output wheel of the first shaft.
The first toothed wheel is an input wheel of the first shaft.
Viewed in a plane perpendicular to the first axis of rotation, the ramp of the deflector has a shape that has a circumferential (or tangential) component that increases with increasing proximity to the first axis of rotation.
The reduction device comprises an input shaft parallel to the first shaft and a first double reduction stage comprising:
   on the one hand, for a first gear ratio, a first pinion coaxial with and unable to rotate independently of the input shaft and a fourth toothed wheel meshing with the first pinion and able to cause the first shaft to rotate about the first axis of rotation; and
   on the other hand, for a second gear ratio, a second pinion coaxial with and unable to rotate independently of the input shaft and the first toothed wheel meshing with the second pinion and able to cause the first shaft to rotate about the first axis of rotation,
   the reduction device comprising a ratio-selection device able to secure to the first shaft such that it cannot rotate independently thereof, either the first toothed wheel or the fourth toothed wheel.

Thus, the invention is particularly beneficial in this two-ratio reduction architecture where it is tricky to disperse the lubricant properly. Because the first toothed wheel is necessarily driven in rotation when the electric machine is operating (whatever the gear ratio selected), the lubricant is able to be dispersed properly whatever the gear ratio selected.

The invention also relates to a powertrain comprising an electric machine and a reducer as described above. Where appropriate, the electric machine comprises a rotor shaft which may be coaxial with and unable to rotate independently of the input shaft of the reducer.

Further features and advantages of the invention are revealed by the following description of non-limiting exemplary embodiments of the various aspects of the invention.

### BRIEF DESCRIPTION OF THE FIGURES

Further features and advantages of the invention will become apparent from reading the following description, with reference to the appended figures, in which:

FIG. 1: illustrates a side view of a reducer according to a first embodiment, shown without the housing.

FIG. 2: illustrates a perspective view of the reducer of FIG. 1, shown without the housing and without the oil collector.

FIG. 3: illustrates a perspective view of the deflector of the first embodiment, with the housing and the differential wheel removed.

FIG. 4: illustrates a view schematically showing the mounting of the deflector of the first embodiment in the housing (without the wheel of the differential).

FIG. 5: illustrates a view of part of the housing collaborating with the deflector, according to the first first embodiment.

FIG. 6: illustrates a view illustrating the collaboration between the protrusion of the deflector and the annular groove of the driven wheel, according to the first embodiment.

FIG. 7: illustrates a partial side view of a deflector according to a second embodiment.

FIG. 8: illustrates a perspective view of a deflector according to a third embodiment.

FIG. 9: illustrates a perspective view of a deflector and of the bottom of a housing according to a fourth embodiment.

### DETAILED DESCRIPTION OF AN EMBODIMENT

In the following description, the first axis of rotation is termed axis of rotation X, the second axis of rotation is termed axis of rotation Y, and the third axis of rotation is termed axis of rotation Z.

In the description and the claims, the terms “external” and “internal” and the orientations “axial” and “radial” will be used to denote elements of the transmission system according to the definitions given in the description. By convention, the “axial” orientation refers to the reference axes X, Y or Z or to directions parallel to these axes, and the “radial” orientation is directed orthogonally to the reference axes X, Y and Z. A “radially internal” element is located closer to the reference axis than a “radially external” element.

The first shaft mentioned above and in the set of claims corresponds to the intermediate shaft 120 in the embodiments described hereinbelow.

The first toothed wheel mentioned above and in the set of claims corresponds to the driven wheel 122 of the second gear ratio in the embodiments described hereinbelow.

The second toothed wheel mentioned above and in the set of claims corresponds to the differential wheel 30 in the embodiments described hereinbelow.

The third toothed wheel mentioned above and in the set of claims corresponds to the third pinion 123 in the embodiments described hereinbelow.

The fourth toothed wheel mentioned above and in the set of claims corresponds to the driven wheel 121 of the first gear ratio in the embodiments described hereinbelow.

The terms “upper”, “lower”, “high”, “low”, “top” and “bottom” should be considered when looking at the speed reducer in a position/inclination similar to its position when it is mounted on a vehicle parked horizontally.

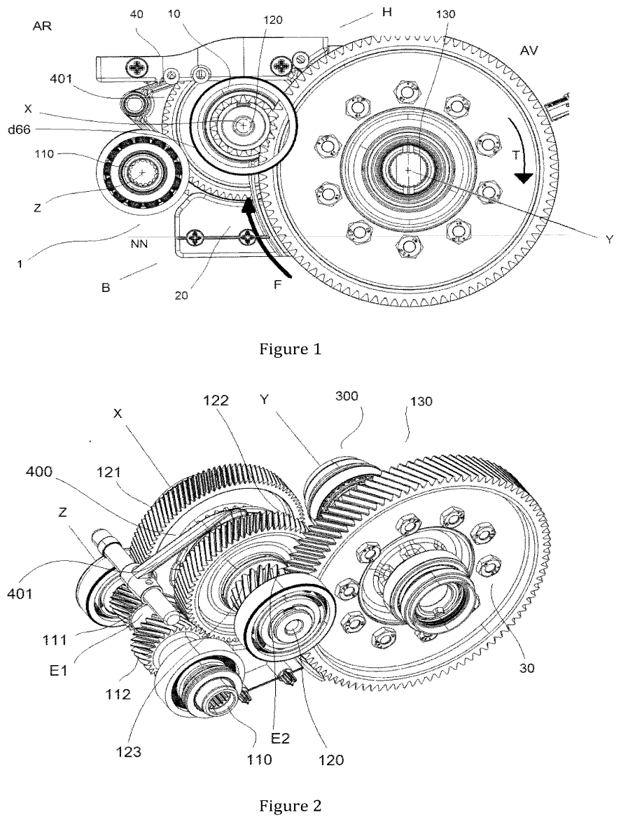

FIG. 1 is a simplified side view of a speed reducer 1 (also referred to as a reducer) shown without its housing so that the reduction device can be seen. FIG. 2 shows the same reducer 1 in perspective, without the housing, and without the oil collector 40 present in FIG. 1.

In FIG. 1, the reducer is shown in a position corresponding to its position when it is mounted in a vehicle parked on a horizontal plane. It comprises a relatively low part and a relatively high part.

This reducer comprises two gear ratios. It may form the main powertrain of a vehicle, in particular an electric motor vehicle, or else a secondary powertrain. For example, this may be a secondary electric powertrain of a hybrid vehicle, in particular intended for the rear axle of the vehicle.

The reducer 1 comprises:
an input shaft 110 intended to be driven by a motor, in particular an electric machine, about an axis of rotation Z,
a differential-drive device 130 (also referred to as a differential) comprising a differential wheel 30 and a differential axle 300 capable of rotating two half-shafts about an axis of rotation Y,
an intermediate shaft 120 movable in rotation about an axis of rotation X, and capable of transmitting a torque between the input shaft 110 and the differential wheel 30.

The input shaft 111 is capable of being driven coaxially by a rotor shaft of an electric machine, in particular by means of splines.

The differential wheel 30 drives the differential axle 300 in rotation about the axis of rotation Y in a known manner. The differential wheel 30 is the drive wheel of the differential-drive device.

The axes of rotation X, Y and Z are parallel.

The axis of rotation Y is intended to be situated, on the vehicle, toward the front of the vehicle in relation to the axis of rotation X. Likewise, the axis of rotation X is intended to be situated, on the vehicle, toward the front of the vehicle in relation to the axis of rotation Z.

In other words, the reducer has a front part AV and a rear part AR. The front part AV is intended to be positioned further toward the front of the vehicle than the rear part AR. The differential is therefore positioned toward the front of the reducer and the input shaft toward the rear. Thus, when the vehicle has a forward gear ratio engaged, the differential wheel 30 rotates in the direction indicated by the arrow T.

The diameter of the differential wheel 30 is greater than the diameter of the driven wheel 122 of the second gear ratio, for example between 1.5 and 4 times greater, and the axis of rotation X is arranged, when the reducer is in a position corresponding to that adopted when mounted on a vehicle parked horizontally, above the axis of rotation Y.

In particular, if considering, on the one hand, a first plane passing through the axis of rotation X and the axis of rotation Y and, on the other hand, a second plane corresponding to the horizontal plane passing through the axis of rotation Y, an angle of between 10 and 45 degrees separates the first plane and the second plane.

The reducer 1 comprises a first double reduction stage E1 between the input shaft 110 and the intermediate shaft 120. The reducer also comprises a second reduction stage E2 between the intermediate shaft 120 and the differential axle 300.

The first double reduction stage E1 comprises:
on the one hand, for the first gear ratio, a first pinion 111 unable to rotate independently of the input shaft 110 with respect to the axis of rotation Z and a driven wheel 121 meshing with the first pinion 111 and able to cause the intermediate shaft 120 to rotate about the axis of rotation X; and
on the other hand, for the second gear ratio, a second pinion 112 unable to rotate independently of the input shaft 110 with respect to the axis of rotation Z and a driven wheel 122 meshing with the second pinion 112 and able to cause the intermediate shaft 120 to rotate about the axis of rotation X.

The designations “driven wheel 121 of the first gear ratio” and “driven wheel 122 of the second gear ratio” will be employed in the remainder of the description.

The second reduction stage E2 comprises a third pinion 123 unable to rotate independently of the intermediate shaft 120 with respect to the axis of rotation X and the differential wheel 30 able to rotate about the axis of rotation Y, the differential wheel 30 meshing with the third pinion 123.

The driven wheel of the second gear ratio 122 and the differential wheel 30 are axially offset relative to one another.

The change in gear ratio therefore occurs at the first double reduction stage E1 by means of a ratio-selection device 400. The ratio-selection device 400 comprises a fork 401 capable of translational movement parallel to the axis of rotation X. This fork may be moved by a known actuating device (not shown). The fork 401 allows an engagement sleeve to be slid along the axis of rotation X so as to secure the intermediate shaft 120 with the driven wheel 121 of the first gear ratio, or with the driven wheel 122 of the second gear ratio. To this end, the driven wheel 121 of the first gear ratio and the driven wheel 122 of the second gear ratio each comprise an engagement toothset arranged about the axis of rotation X and capable of collaborating with the engagement sleeve. The driven wheel 121 of the first gear ratio and the driven wheel 122 of the second gear ratio are rotatably mounted about the intermediate shaft 120 and the engagement sleeve is itself mounted on the intermediate shaft 120 so that it is unable to rotate independently thereof, for example by means of splines. It is therefore the collaboration between the engagement sleeve and the engagement toothset of the driven wheel 121 of the first gear ratio or, respectively, of the driven wheel 122 of the second gear ratio, that enables the driven wheel 121 of the first gear ratio or, respectively, the driven wheel 122 of the second gear ratio to be secured to the intermediate shaft 120 without the ability to rotate independently thereof about the axis of rotation X. The engagement sleeve comprises for example engagement teeth at its two axial ends.

As a preference, the engagement sleeve may be kept spaced apart from the driven wheel 121 of the first gear ratio and from the driven wheel 122 of the second gear ratio in a neutral position, in which no torque is transmitted between the input shaft 110 and the intermediate shaft 120 as neither of the driven wheels 121 and 122 of the first and second gear ratios collaborates with the engagement sleeve. The neutral position corresponds to a disconnected mode. In this mode, the electric machine no longer transmits torque to the two half-shafts, or therefore to the wheels in contact with the roadway, and vice versa.

The reduction device, in particular the bearings supporting the shafts 110, 120, the meshing between the pinions 111, 112 and the driven wheels 121, 122, the meshing between the pinion 123 and the differential wheel 30 and also the engagement sleeve require lubrication, in particular with oil. Here, the lubrication of the reducer is passive. In other words, it does not comprise a pump dedicated to circulating a lubricant within the reducer. The lubrication here therefore relies on the presence of an oil bath at the bottom of the reducer and on this oil being conveyed in the direction of the various elements of the reducer that are to be lubricated (bearings, meshing gears, engagement toothsets) by virtue, in particular, of the splashing of oil caused by the rotation of the differential wheel 30, of the pinions 111, 112, 123 and of the driven wheels 121, 122, and by virtue of gravity.

When the vehicle is stationary, a lower portion of the differential wheel 30 is immersed in the oil bath. When the vehicle is in motion, the differential wheel 30 rotates about the axis of rotation Y, which makes it possible to disperse oil, in particular to cause it to rise, as indicated by the arrow F. The oil level at the bottom of the reducer is therefore lower down.

In order to improve the passive lubrication of the reducer, a deflector 20 is arranged, in the lower part of the reducer, to promote the rising of the lubricant, and a collector 40 is arranged in the upper part so as, on the one hand, to receive the lubricant which has been raised beforehand and, on the other hand, to redirect the lubricant to various points of the reducer, in particular by gravity.

The deflector 20 is able to guide the splashing of oil.

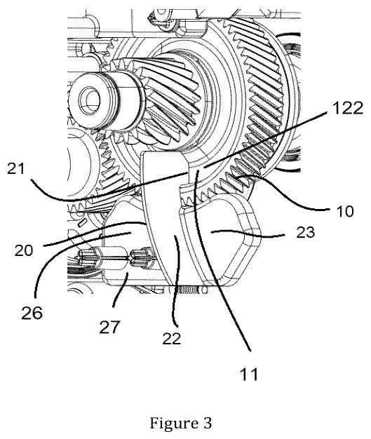

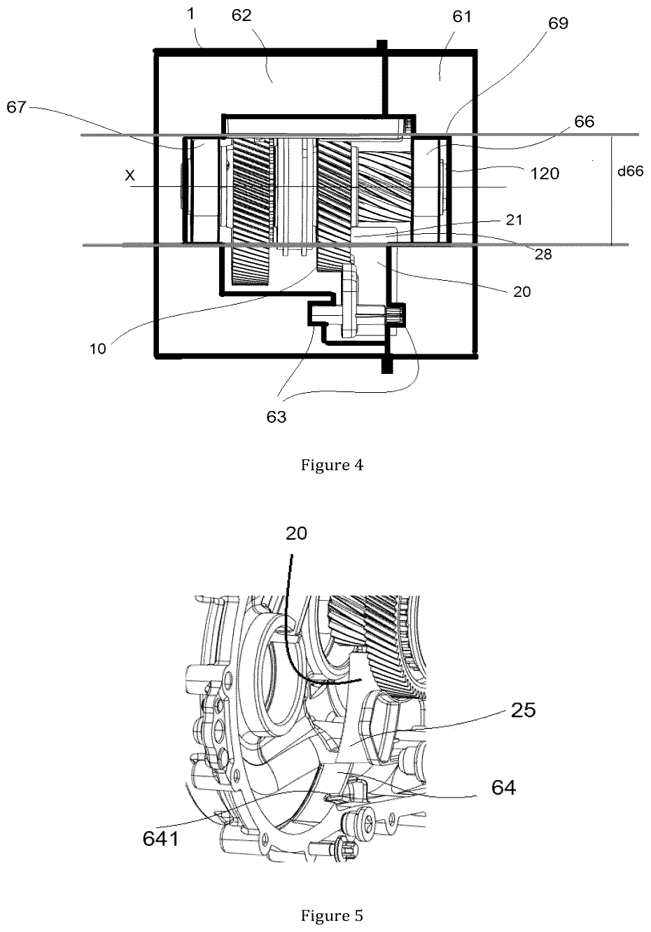

A first embodiment of the deflector and of the driven wheel 122 of the second gear ratio with which this deflector collaborates is shown in FIGS. 3 and 4.

The toothed wheel 122 of the second gear ratio comprises an annular groove 11 arranged around the axis of rotation X and open axially to one side of the toothed wheel 122 of the second gear ratio. Here, the annular groove 11 is arranged on the right-hand side of the driven wheel 122 of the second gear ratio.

The driven wheel 122 of the second gear ratio comprises a hub 1223, a toothed peripheral band 1221 arranged radially to the outside of the hub 1223, and a wheel disk 1222 connecting the hub 1223 and the toothed peripheral band 1221.

The annular groove 11 of the driven wheel 122 is delimited on a flank of the driven wheel 122 by the hub 1223, the wheel disk 1222 and the toothed peripheral band 1221.

The deflector 20 comprises a ramp 25 capable of guiding the lubricant. A portion of the ramp 25 is arranged inside the annular groove 11 of the driven wheel 122 of the second gear ratio. The ramp is configured to direct the lubricant into the annular groove of the driven wheel 122 of the second gear ratio so that the lubricant is centrifuged by the driven wheel 122 of the second gear ratio and thus redirected toward the top of the reducer.

The lower edge of the ramp 25 is preferably arranged below the oil level, in particular below the nominal level NN. The nominal level corresponds to the indicative oil level inscribed on the reducer when the vehicle is stationary. Alternatively, the nominal level may correspond to the horizontal plane passing through the lower edge of the opening intended for filling/emptying the reducer. The driven wheel 122 of the second gear ratio is for its part arranged completely above the nominal oil level.

The ramp 25 comprises a main guideway 22 and an axial protrusion 21 extending the main guideway 22 and projecting axially from the main guideway 22.

The axial protrusion 21 is arranged to a large extent inside the annular groove 11 of the driven wheel 122 of the second gear ratio. The main guideway 22 is itself arranged entirely outside the annular groove 11 of the driven wheel 122 of the second gear ratio.

The differential wheel 30 comprises a toothed peripheral band of which part is arranged, with respect to the axis of rotation Y, radially facing the main guideway 22 of the ramp 25.

The ramp 25 of the deflector, notably the main guideway 22 of the ramp 25, is arranged so that it covers the toothed peripheral band of the differential wheel 30 along a limited angular sector with respect to the axis of rotation Y. The angular sector is comprised between 20 and 90 degrees, for example between 30 and 50 degrees.

In addition, the ramp 25, notably the main guideway 22 of the ramp 25, is spaced away from the toothset of the differential wheel 30 by a first clearance 31. This first clearance may be between 2 and 5 mm.

The main guideway 22 advantageously has a shape that hugs the toothed peripheral band of the differential wheel 30 covered by the ramp. In particular, in a plane perpendicular to the axis of rotation Y, the ramp 25 has the form of a circular arc.

The deflector 20 further comprises a shield 23 arranged to at least one side of the ramp 25 so as to prevent the lubricant from dropping off that side of the ramp 25. The shield 23 is situated on the same side of the ramp 25 as the driven wheel 122 of the second gear ratio. The shield 23 and the axial protrusion 21 are situated on the same side of the main guideway 22 of the ramp 25.

The shield 23 extends in a plane substantially perpendicular to the axis of rotation Y. The shield takes the form of a plate arranged parallel to the differential wheel 30. The shield 23 is arranged axially facing a portion of the differential wheel 30. The shield thus borders the ramp over at least half its length.

The lower edge of the shield 23 may be arranged below the oil level, in particular below the nominal level.

In this instance, the bottom of the shield 23 coincides with the bottom of the ramp 25.

The third pinion 123 is arranged beyond an upper end of the ramp of the deflector. The outside diameter of the third pinion 123 is smaller than the outside diameter of the annular groove 11.

The reducer contains a lubricant such as oil, and when the reducer is in a position corresponding to the position adopted when it is mounted on a vehicle parked horizontally, a lower end of the ramp is immersed in the lubricant.

The deflector 20 also comprises a mounting portion 26.

The mounting portion 26 comprises a plate 27 extending substantially in a plane perpendicular to the axis of rotation X. The plate is preferably arranged in the continuation of the shield 23, beyond the ramp 25. In other words, the plate 27 and the shield 23 are arranged in the one same plane.

The mounting portion 26 also comprises a plurality of fixing studs 29 collaborating with receptacles 63 arranged in the housing 60 of the reducer.

The fixing studs 29 are arranged on each side of the plate 27. In the embodiment shown in FIG. 3, the deflector comprises four fixing studs, namely two fixing studs 29 arranged on one side of the plate 27 and two other fixing studs 29 arranged on the other side of the plate. The fixing studs 29 project from the plate. They extend perpendicular to the plate 27.

The housing comprises a first part 61 and a second part 62, these being assembled with one another, enclosing the reduction device. The first part 61 may also form all or part of the housing of the electric machine.

The first part 61 comprises two mounting receptacles 63 collaborating with two fixing studs 29 of the deflector and the second part 62 comprises two other mounting receptacles 63 collaborating with two other fixing studs 29 of the deflector.

In another embodiment which has not been shown, the mounting receptacles are formed on the deflector and the fixing studs are formed on the housing.

FIG. 4 schematically shows the mounting of the deflector 20 in the two parts 61 and 62 of the housing 60.

The intermediate shaft 120 extends along the axis of rotation X and carries the driven wheel 122 of the second gear ratio.

A first bearing 66 guides the rotation, about the axis of rotation X, of the intermediate shaft 120. The first bearing 66 is mounted in a first receptacle 69 in the first part 61 of the housing 60. The first bearing 66 supports a first end of the intermediate shaft 120.

A second bearing 67 guides the rotation, about the axis of rotation X, of the intermediate shaft 120. The second bearing 67 is mounted in a second receptacle in the second part 62 of the housing 60.

Because it is manufactured as a component distinct from the housing 60 it is possible for a flow sector 28 of the deflector 20, notably comprising the axial protrusion 21, to be arranged, radially with respect to the first axis of rotation X, closer to the axis of rotation X than the radially external periphery of the first bearing 66. This flow sector 28 of the ramp 25 corresponds here to an end region of the ramp.

The end region 28 of the deflector is arranged, axially along the first axis X, between the driven wheel 122 of the second gear ratio and the first bearing 66.

This feature is also visible in FIG. 1 in which only the outer ring of the bearing 66 with the outside diameter d66 thereof is shown. It may be seen that the deflector encroaches into an axial right cylindrical volume centered on the axis of rotation X and the diameter of which corresponds to the outside diameter d66 of the first bearing 66.

The end region 28 of the deflector is arranged, axially along the first axis X, between the driven wheel of the second gear ratio and the first bearing 66.

As was seen earlier, because of the collaboration between the axial protrusion and the annular groove of the driven wheel 122 of the second gear ratio, the end region 28 of the deflector is also arranged, radially with respect to the first axis X, closer to the axis of rotation X than the radially external periphery of the driven wheel 122 of the second gear ratio.

In FIG. 5 it may be seen that the housing 60 also comprises a complementary ramp 64 arranged in the continuation of the ramp 25 of the deflector 20 so that the lubricant is guided from the complementary ramp 64 of the housing 60 toward the ramp 25 of the deflector 20.

It may be noted that the complementary ramp 64 is equipped with a passage 641 to allow the return of lubricant at the base of the complementary ramp, notably under the effect of gravity. Thus, the lubricant is able to drop back into the bottom of a circular recess in the housing corresponding to the location of the differential wheel 30. As a preference, the bottom of the circular recess is the lowermost point of the interior volume of the housing.

The complementary ramp and the passage may be produced on the two parts 61 and 62 of the housing 60. This is particularly beneficial when the differential wheel 30 is located in the plane of axial assembly of the first part 61 and of the second part 62 of the housing 60.

The deflector is made of plastic as a component distinct from the housing, for example using an injection molding method. Thus, various shapes of deflector are conceivable.

In a different configuration of reducer, it is possible to envision for the deflector to be formed as a single piece with one or other of the first part or the second part of the housing.

Returning to the embodiment of FIG. 3, it may be seen that the axial protrusion 21 extends substantially in a plane parallel to the axis of rotation X, or even in a plane containing the axis of rotation X.

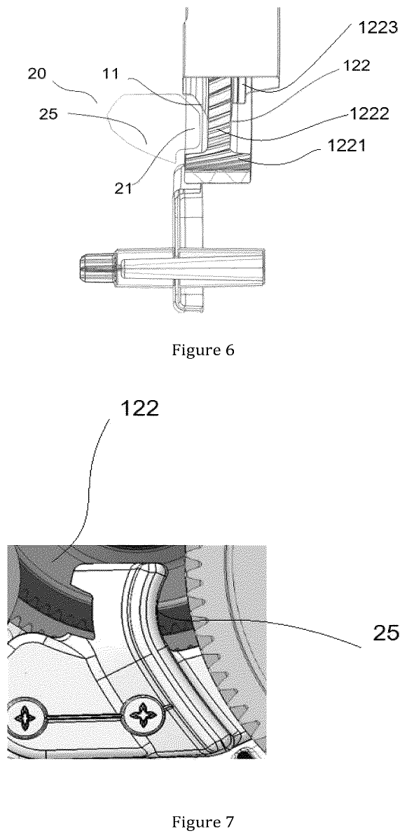

When viewed in the plane of the axial protrusion (FIG. 6), the annular groove 11 has a cross section of a shape that complements the edge of the axial protrusion (21). In other words, the axial protrusion 21 and the annular groove 11 nestle axially one inside the other. A second axial clearance of between 1 and 3 mm may for example separate the protrusion 21 and the groove 11. This clearance may be greater in the axial direction than in the radial direction.

In the embodiment of FIG. 6, viewed in a plane perpendicular to the axis of rotation X, the ramp 25 of the deflector has a shape the inclination of which has a circumferential or tangential (with respect to the axis of rotation X) component that increases with increasing proximity to the axis of rotation X. Thus, the oil is progressively guided in a direction that brings it closer to the circumferential direction of rotation of the driven wheel 122 of the second gear ratio.

In the embodiment of FIG. 8, the protrusion has a thickness that increases axially, with increasing proximity to the driven wheel 122 of the second gear ratio. This makes it possible to create a relief angle that is advantageous for demolding the deflector.

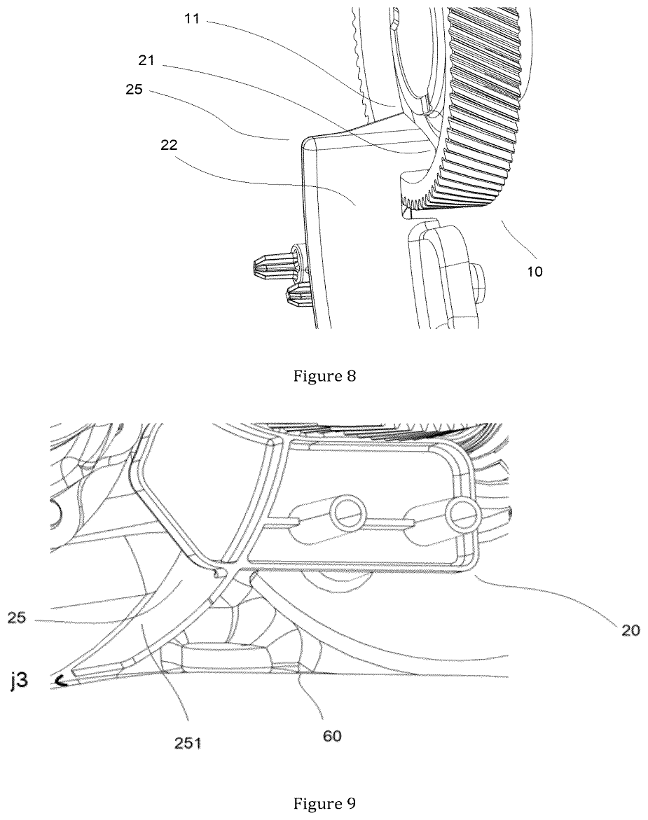

In the variant of FIG. 9, the housing has no complementary ramp and the ramp comprises a lower portion extending from the bottom of the shield 23 toward the bottom of the housing 60.

A third clearance j3 separates the bottom of the ramp 25 and the bottom of the housing 60 so as to allow the return of oil, notably under the effect of gravity, under the lower end of the ramp 25 (in other words under the bottom of the lower portion of the ramp).

In the various embodiments described here, the deflector makes it possible to raise the oil in a central region of the reducer that is nevertheless congested by the intermediate shaft 120, the driven wheels 121, 122 and the pinion 123.

Of course, the invention is described in the foregoing by way of example. It will be understood that a person skilled in the art is capable of producing various alternative embodiments of the invention without thereby departing from the scope of the invention. For example, the invention which has been described here in the context of a reducer with two gear ratios may also be applied to a reducer with a single gear ratio or more than two gear ratios.

It must be emphasized that all of the features, as they appear to a person skilled in the art on the basis of the present description, the drawings and the accompanying claims, even if in practice they have been described only in relation to other given features, both individually and according to any combination, may be combined with other features or groups of features disclosed herein, provided that this has not been expressly excluded and that technical circumstances do not make such combinations impossible or pointless.

1. A speed reducer for a powertrain, comprising:
a reduction device comprising a first shaft extending along a first axis of rotation,
a housing enclosing the reduction device and comprising a first part and a second part, these being axially assembled with one another,
a first bearing arranged to guide the rotation, about the first axis of rotation, of the first shaft, and the first bearing being mounted in a first receptacle of one of the first part of the housing and the second part of the housing-, the first bearing having a radially external peripheral contour,
a deflector comprising a ramp capable of guiding a lubricant, the deflector being arranged in the housing,
wherein the deflector is manufactured as a component distinct from the housing, and wherein the ramp comprises a flow sector which is situated closer to the first axis of rotation X than the radially external peripheral contour of the first bearing.

2. The speed reducer as claimed in claim 1, wherein the first shaft coaxially carries a plurality of toothed wheels, and the flow sector is also arranged closer to the first axis of rotation X than the radially external periphery of the toothed wheel of largest diameter carried by the first shaft.

3. The speed reducer as claimed in claim 1, wherein the flow sector is an end region of the ramp of the deflector.

4. The speed reducer as claimed in claim 1, wherein the reduction device comprises a first toothed wheel carried coaxially, with respect to the first axis of rotation, by the first shaft and the first toothed wheel comprises a hub, two flanks and a toothed peripheral band, the flow sector being arranged so as to splash the lubricant against a flank of the first toothed wheel.

5. The speed reducer as claimed in claim 1, wherein the flow sector is arranged, axially along the first axis of rotation, between the first toothed wheel and the first bearing.

6. The speed reducer as claimed in claim 1, wherein the flank of the first toothed wheel against which the lubricant is splashed comprises an annular groove inside which a part of the flow sector is arranged.

7. The speed reducer as claimed in claim 1, wherein the first bearing supports a first end of the first shaft.

8. The speed reducer as claimed in claim 1, wherein the deflector is fixed with respect to the housing.

9. The speed reducer as claimed in claim 1, wherein the deflector is made of plastic, for example using an injection molding method.

10. The speed reducer as claimed in claim 1, the preceding claims, wherein the deflector comprises a mounting portion comprising a plurality of fixing elements collaborating with complementary fixing elements arranged in the housing of the reducer.

11. The speed reducer as claimed in claim 1, wherein the housing of the reducer comprises a first part and a second part, these being assembled with one another, enclosing the reduction device.

12. The speed reducer as claimed in claim 11, wherein the first bearing is mounted in a first receptacle of the first part of the housing and a second bearing makes it possible to guide the rotation, about the first axis of rotation, of the first shaft, the second bearing being mounted in a second receptacle of the second part of the housing, and the flow sector is situated closer to the first axis of rotation than the radially external peripheral contour of the second bearing.

13. The speed reducer as claimed in claim 10, wherein the fixing elements are arranged in such a way that at least one fixing element is fixed to the first part of the housing and at least one fixing element is fixed to the second part of the housing.

14. The speed reducer as claimed in claim 2, wherein the flow sector is an end region of the ramp of the deflector.

15. The speed reducer as claimed in claim 2, wherein the reduction device comprises a first toothed wheel carried coaxially, with respect to the first axis of rotation, by the first shaft and the first toothed wheel comprises a hub, two flanks and a toothed peripheral band, the flow sector being arranged so as to splash the lubricant against a flank of the first toothed wheel.

16. The speed reducer as claimed in claim 2, wherein the flow sector is arranged, axially along the first axis of rotation, between the first toothed wheel and the first bearing.

17. The speed reducer as claimed in claim 2, wherein the flank of the first toothed wheel against which the lubricant is splashed comprises an annular groove inside which a part of the flow sector is arranged.

18. The speed reducer as claimed in claim 2, wherein the first bearing supports a first end of the first shaft.

19. The speed reducer as claimed in claim 2, wherein the deflector is fixed with respect to the housing.

20. The speed reducer as claimed in claim 2, wherein the deflector is made of plastic, for example using an injection molding method.
